(19) United States
(12) Patent Application Publication
(10) Pub. No.: US 2023/0162416 A1
(43) Pub. Date: May 25, 2023

(54) METHOD FOR MODIFYING A USER'S VIDEO BODY IMAGE BASED ON DATA INPUTS WITH STOP POINT

(71) Applicant: ENVISIONBODY, LLC, Belleair Bluffs, FL (US)

(72) Inventor: Salina Dearing Ray, Belleair Bluffs, FL (US)

(21) Appl. No.: 17/889,031

(22) Filed: Aug. 16, 2022

Related U.S. Application Data
(60) Provisional application No. 63/281,906, filed on Nov. 22, 2021.

(51) Int. Cl. G06T 11/60; G06T 7/70

(52) U.S. Cl. CPC G06T 11/60; G06T 7/70; G06T 2207/20084; G06T 2207/10016

(57) ABSTRACT

A method for changing a body image. The method includes inputting data parameters into a computing device, providing an image to a machine, manipulating the image, and displaying the manipulated image. In this method, the machine utilizes one or more of artificial intelligence, machine learning, artificial neural networks, and deep learning to provide the modified image.

### FIELD OF THE INVENTION

This invention relates to a system and method for enhancing a user's video body image that is based on a combination of data inputs from a user or professional, artificial intelligence, machine learning, neural networks, and deep learning and the like technologies to illustrate weight loss, weight gain, muscle loss and/or muscle mass. This invention relates to processing a body in a real time video and/or still image based on inputs. This serves as a benefit for illustrating cosmetic procedures and/or services, a method of increasing diet/exercise motivation, advertising and or general entertainment purposes.

### BACKGROUND

Cosmetic surgery and fat reducing procedures such as liposuction and/or non-surgical procedures such as CoolSculpting have been performed for years to improve one's appearance and increase self-confidence. Doctor's typically show past surgery patients results as still before and after images. Cosmetic clinics and spas that offer fat reduction procedures typically show a potential new customer, during a consultation, older before and after still images of past customers that have used the service as an example of what they can expect.

Various industries have used before and after images to advertise their product or service. However, they lack the individual personalization and user engagement because they are a still image of someone else.

Various methods have been used to try to increase exercise and diet motivation. Before and after still images have been used to encourage people to buy a product or service. Fitness trainers have had to show examples of before and after images to display goal settings. These are normally of other people and not relatable or personalized.

Fitness manufacturers have produced fitness equipment that engages the user with a fitness class or instructor.

Several beauty filter touch up apps provide the ability to change your video image. However, they lack the individual personalization and user engagement because they are shown as a layover on top of a user's image utilizing augmented reality. Beauty filters are essentially automated photo editing tools that use artificial intelligence and computer vision to detect facial and or body features and change them. They use computer vision to interpret the things the camera sees, and tweak them using augmented realty according to rules set by the filters' creator. The beauty filters lack producing video body modification that corresponds to a respective physical exercise and/or a particular diet and/or cosmetic service, or surgery and or body tweaking, morphing the user's image utilizing deep learning technology that directly changes the image of the user; not placing a layover on top of it.

### SUMMARY OF THE INVENTION

One embodiment is a method for selling a cosmetic muscle building and/or fat reduction or fat and or implants augmentation procedure or services that includes providing a real time video and/or still body image to a machine that is captured in real time, manipulating the video and/or still body image to provide a modified body image, identifying at least one body part, and displaying the at least one body part as the modified video and/or still body image.

In an example of this embodiment is a method for exercise and/or diet motivation, that includes providing a real time video and/or still image to a machine that is captured in real time, on demand, manipulating the video and/or still image to provide a modified body image, identifying at least one body part, and displaying the at least one body part as the modified video and/or still image.

In an example of this embodiment is a method for advertising products and or services, that includes providing a real time video and/or still image to a machine that is captured in real time, on demand, manipulation manipulating the video and/or still image to provide a modified body image, identifying at least one body part, and displaying the at least one body part as the modified video and/or still image.

In one example of this embodiment, the machine utilizes artificial intelligence, machine learning, neural networks, and deep learning (“DL”) to provide the modified image. In one example, the machine utilizes artificial intelligence, machine learning, neural networks, and deep learning, to provide a stop point of the modification of the body image video. In one example of this embodiment, the machine utilizes artificial intelligence, machine learning, neural networks, and deep learning to detect a pose. In one example of this embodiment, the machine utilizes technologies based on neural networks deep learning, machine learning, deep learning, and artificial intelligence to provide the modified image. In another example, the video body image is processed and uploaded to the machine from a remote location and/or cloud based. In yet another example, the video image is captured by the machine by a camera coupled to the machine. In yet another example, the video image is captured by a camera on the machine whereby the camera and the machine are comprised in one unit. In another example the video image of a user and the modified video and image comprises a change to the size of at least one of the users body part and or area. In another example the at least one body part is identified by artificial intelligence camera vision full body camera tracking. In another example the at least one body part is identified by artificial intelligence camera vision full body camera tracking to detect a pose. In another example, the at least one body area/part is processed through an artificial intelligence, machine learning, and deep learning algorithms that readjust identified body areas based on input parameters such as, but not limited to user's body position to the image capture, voice, gender, height, pose, timeline, user's health data, heartrate, percentage and or measurements of loss weight desired, percentage and or measurements of weight gain desired, body parameters, percentage and or measurements of muscle reduction desired, percentage and or measurements of muscle mass increase desired, current weight and/or body measurements, diet, calorie intake, exercise and or non-exercise, BMI, professionals' inputs, voice command, weight loss desired and or weight gain desired, muscle mass increase desired and or muscle mass reduction, diet, exercise, goals; cosmetic procedure or service predicted outcome. In yet another example, the displaying step comprises providing the at least one modified video body image to a user display coupled to the machine. In another example the displaying step comprises providing the at least one modified video body image to a user display that wirelessly communicates with the machine. In yet another example, the video image is captured by a camera on the machine whereby the camera and the machine are comprised in one unit. In yet another example, the body modification is weight loss. In yet another example, the body modification is weight gain. In yet another example, the body modification is increase in muscle mass. In yet another example, the body modification is muscle decrease. In yet another example, the body modification is a cosmetic implant. In yet another example, the at least one body modification comprises at least one body part and/or area or entire body. In another example the user sees their modified video and/or still image completed at one time. In another example, the user sees their modified video and/or still image in smaller increments over a longer period of time. In yet another example, the modified video and/or still image is display as a split screen. This can be captured and/or displayed remotely, processed in the cloud, or on any computer device, and or coupled to the device or method such as but not limited to a tablet, cell phone, computer mirror, computer exercise machine, computer desktop, computer laptop, AR and/or VR glasses and/or headset, metaverse or hologram. The user's image may be captured and scanned by a 3D scanner first and then processed and displayed on computer glasses, headset, AR and or VR headsets and or hologram and or metaverse, and or smart mirror, tablet, computer and or smart phone. The 3D scanner may be coupled to the computer device or a separate device.

In one example of this embodiment, the machine utilizes artificial intelligence, machine learning, neural networks, and deep learning to provide the modified image. In one example, the machine utilizes artificial intelligence, machine learning, neural networks, and/or deep learning to provide a stop point of the modification of the body image and or image video. In one example of this embodiment, the machine utilizes machine learning deep learning to provide diet and or activity level suggestions based on the modified image. In another example, the video body image and or image is processed and uploaded to the machine from a remote location and/or cloud based. In yet another example, the image or and video image is captured by the machine by a camera coupled to the machine. In yet another example, the image and or video image is captured by the machine utilizing a camera whereby the camera and the machine are comprised in one unit. In yet another example, the image is captured in a remote location. In another example the video image of a user and the modified video image and or image comprises a change to the user's size of at least one body part and or area. In another example the at least one body part is identified by artificial intelligence computer vision full body camera tracking. In another example the at least one body part pose and or position is identified by artificial intelligence computer vision full body camera tracking. In another example, the at least one body area/part is identified and processed through a deep learning program that readjust identified body areas based on but not limited to the computer vision input parameters, voice command, the professional input parameters and or user's input body parameters to the image capture, gender, height, heartrate, timeline, user's health data, pose, percentage or measurements of loss weight desired, current weight and/or body measurements, calorie intake, BMI, professionals' inputs, weight loss and/or diet, exercise, non-exercise, goals, activity level, daily calorie intake, cosmetic procedure or service predicted outcome. In yet another example, the displaying step comprises providing the at least one before modified video body image and modified video body image side by side. In yet another example, the displaying step comprises providing the at least one before modified video body image and modified video body image is displayed together and or on top of each other. In yet another example, the displaying step comprises providing the at least one modified video body image and or image to a user display coupled to the machine. In another example, the video modified image and or image displayed to the user whereby the display and the machine are comprised in one unit. In another example the displaying step comprises providing the at least one modified video body image or still image to a user display that wirelessly communicates with the machine. In yet another example the processing and/or obtainment of the user's image is in the cloud.

In yet another example, the body modification is weight loss. In yet another example, the body modification is weight gain. In yet another example the body modification is an increase in size measurements and or reductions in size measurements. _In yet another example, the body modification is increase in muscle mass. In another example, the body modification is muscle mass reduction. In yet another example, the body modification is a cosmetic implant. In yet another example, the at least one body modification comprises at least one body part and/or area or entire body. This can be captured on demand and/or displayed remotely or on any computer device, and or coupled to the device or method such as but not limited to a tablet, cell phone, computer mirror, computer exercise machine, computer desktop, AR and/or VR glasses and/or headset, metaverse or as a hologram. The user's image may be captured and scanned by a 3D scanner first and then processed and displayed on computer glasses, headset, AR and or VR headsets and or hologram and or metaverse, and or smart mirror, tablet, computer and or smart phone. The 3D scanner may be coupled to the computer device or a separate device.

In one example, artificial neural network deep learning algorithms use a collection of input data aimed at building deep learning models datasets. Deep learning models are trained by using large sets of labeled data and neural network architectures that learn features directly from the data without the need for manual feature extraction. Machine learning may be combined with deep learning structured algorithms to form predictions and conclusions that result in body morphing to a video image and or still image comprising at least one body part and/or area or entire body of one or more and image morphing displaying size measurement increase and or size measurement decrease, weight gain and or weight loss and or muscle gain and or muscle loss and or cosmetic implant appearance.

Utilizing large datasets artificial neural networks, deep learning networks are formed. When posed with a request or problem to solve, the neurons run mathematical calculations to figure out if there's enough information to pass on the information to the next neuron. Put more simply, they read all the data and figure out where the strongest relationships exist. In the simplest type of network, data inputs received are added up, and if the sum is more than a certain threshold value, the neuron “fires” and activates the neurons it's connected to. As the number of hidden layers within a neural network increases, deep neural networks are formed. Deep learning architectures take simple neural networks to the next level. Using these layers, a developer can build their own deep learning networks that enable machine learning, which can train a computer to accurately emulate human tasks, such as recognizing speech, identifying images or making predictions. Equally important, the computer can learn on its own by recognizing patterns in many layers of processing.

There are many classes of artificial neural network deep learning algorithms that are commonly used to train and predict output from complex data, and some are better suited to perform specific task. For pose detection, we are using Convolutional Neural Network (CNN) based model combined with specialized pose decoding algorithms. CNN is used to train deep learning algorithms. In deep learning, a convolutional neural network is a class of artificial neural network (ANN), most commonly applied to analyze visual imagery. Convolutional neural networks are distinguished from other neural networks by their superior performance with image inputs. They have three main types of layers: Convolutional Layer, Pooling Layer, and Fully Connected Layer. The structure of the CNN can become hierarchical as the later layers can see the pixels within the receptive fields of prior layers. Ultimately, the convolutional layer converts the image into numerical values, allowing the neural network to interpret and extract relevant patterns.

The convolutional layer is the first layer of a convolutional network. While convolutional layers can be followed by additional convolutional layers or pooling layers, the fully-connected layer is the final layer. With each layer, the CNN increases in its complexity, identifying greater portions of the image. Earlier layers focus on simple features, such as colors and edges. As the image data progresses through the layers of the CNN, it starts to recognize larger elements or shapes of the object until it finally identifies the intended object.

The Convolutional neural network may use a Graphics Processing Unit also known as GPU, that is utilized to speed up the processing and computations of the CNN. The training of CNN can be quite slow due to the amount of computations required for each iteration. A graphics processing unit (GPU) is a specialized electronic circuit designed to rapidly manipulate and alter memory to accelerate the creation of images and intensive graphics-based tasks, such as video rendering that often require a dedicated or discreet GPU notably in the form of a graphics card. GPUs can perform multiple, simultaneous computations. This enables the distribution of training processes and can significantly speed machine learning operations. With GPUs, you can accumulate many cores that use fewer resources without sacrificing efficiency or power. Although we have included the use of GPU it is not necessary to utilize a GPU when working with a CNN. Algorithmic nonlinear math is used from tabular data and or datasets that contains information of the body including but not limited to large amounts of images of whole bodies, body parts, body segments, images of various body sizes, body positions, pose, physical characteristics data, gender, age, weight, height, shapes, body sizes and or weights and or muscle mass dimensions, measurements, timeline, and BMI.

When using images, CNN helps a machine learning or deep learning model “look” by breaking images down into pixels that are given tags or labels. It uses the labels to perform convolutions (a mathematical operation on two functions to produce a third function) and makes predictions about what it is “seeing.” The neural network runs convolutions and checks the accuracy of its predictions in a series of iterations until the predictions start to come true. It is then recognizing or seeing images in a way similar to humans. Large amounts of body images may be provided to train the deep learning computation. The deep learning models can achieve state-of-the-art accuracy, sometimes exceeding human-level performance. Deep learning uses algorithmic models that enable a computer to teach itself about the context of visual data. If enough data is fed through the model, the computer will “look” at the data and teach itself to tell one image from another and form projected outcomes. This data may include custom pose detection algorithms, large amounts of images of whole bodies, body parts, body segments, images of various body sizes, body positions, pose, physical characteristics data, gender, age, weight, height, shapes, body sizes and or weights and or muscle mass dimensions, measurements, timeline, and BMI.

Machine learning and deep learning allows computational models that are composed of multiple processing layers to learn representations of data with multiple levels of abstraction. For example, to display a morphed image as weight loss that corresponds to diet and exercise inputs, voice command, the deep learning models may be trained by inputting mathematical formulas and calculations from datasets that include but not limited to exercise, calories, diet, measurements, gender, height, weights, target weight, and or weight loss and or weight gain calculation datasets. There are various combined computations the deep learning algorithm may use to reach conclusions of how much reduction or addition to body morphing is needed to change the image. For example, the metabolic equivalents, or MET, calculation may be used. MET is the ratio of your working metabolic rate relative to your resting metabolic rate. Your metabolic rate is the rate of energy used per unit of time, whether you are active or sitting still. The value makes it easier to compare different activities to each other. For example, the total calories burned in 1 minute=(3.5 times the metabolic equivalent or MET multiplied by your body weight in kilograms)/200. In this equation, 1 MET equals 3.5 mL of oxygen consumed per kilogram of body weight per minute. For example, say you weigh 150 pounds (approximately 68 kg) and you are running at 7 mph, which has a MET value of 11.5. The formula would work as follows: 11.5×3.5×68/200=13.69 calories per minute. If you run for 30 minutes, you will burn about 410 calories.

The large data provided for training the deep learning models to make conclusions may include datasets of estimated number of calories a person can consume in a day, their calories burned from exercise, their activity level and the corresponding change in the user's shape. For this example, first is to obtain the baseline of the user's current body-shape at their current calorie intake, assuming they remain at rest to use as a benchmark or starting point. This value may be multiplied by an activity factor, dependent on a person's levels of exercise. This gives an estimation of body-weight change and corresponding morphing amount of the user's image, if it is to include exercise. For another example, to display a morphed change to the image equivalent to reducing 1 pound a week, the daily calorie intake must be reduced by 500 calories. Therefore, if 3,500 calories a day are consumed at the user's existing image shape, by reducing that number by 500 each day, it can estimate a weekly weight loss total of 1 pound a week and display the morphed image accordingly to the user. Thusly, if the goal is 12 lbs. total weight loss in 12 weeks, the image morphing would need to display the equivalent of a 12 lbs. reduction to illustrate what the user will look like at the end of 12 weeks.

For another example if using a timeline, if a user has an estimated daily calorie count of 2,500 calories at their current weight and related body shape, consuming 2,000 calories per day for one week would result in 1 pound of weight reduction to the morphed image of the user and the user wants to see their morphed body image changed over a period in smaller increments rather than all at once, it may use the following formula and others to project out 4 weeks ahead and display the morphed image with 4 pounds of weight loss in advance. Thusly, the morphed image displayed to the user the 1^{st} week would be the equivalent of a 4 lbs. reduction. The 2^{nd} week into the 12-week goal, the user could see what they will look like in 8 weeks. This would encourage and motivate the user to keep up their diet and or fitness goals because the enhanced morphed image displayed to the user would seem just within reach. These example formulas are for simple illustration purposes. The Deep Learning computations may be based on many different simple and complex formulas to form conclusions. This may be calculated to display an increase in size or decrease in size of the user and or more or less muscle mass.

In another example of a formula used to change the morphed image in increments of time, such as but not limited to the following percentage equation: the gender is male, the height is 6′4′ and he has a current weight of 260 lbs. Based on this he has a BMI of 31.6. The goal weight is 222 lbs. This means he will have to lose approximately 17% (38 lbs) of his current weight within a 12-week period. To achieve this, each week he will need to lose approximately 1.41% of weight to reach his goal of 17% total lost weight within a 12-week period. The morphed image provided to him the first week is calculated on what he will look like at the five week mark; thus 1.41%×5=7.05%. The deep learning algorithm displays a 7.05% reduction to the morphed image. This serves as one simple example method for deep learning computations using weight loss, but it is understood that this is not limited to this formula. These example formulas are for simple illustration purposes. The Deep Learning computations may be based on many different complex and simple formulas to form conclusions. The transformation displayed in smaller increments may be used for displaying weight loss or weight gain and or more or less muscle mass. This allows the correct amount warping and or pixel dropping, regenerating and or moving of the user's image, images or video image and or video images and displays the image accordingly to the user. This processing may be in one or more body parts and or of a body segment and or overall body of the user.

In another example, machine learning and artificial neural network deep learning algorithms may use data to conclude and predict a stop point so the morphed image stays within a healthy realistic output. Deep learning algorithms extract high level, complex abstractions as data representations through a hierarchical learning process. Complex abstractions are learned at a given level based on relatively simpler abstractions formulated in the preceding level in the hierarchy. Deep learning forms predictions and conclusions in this way. For example, the DL algorithms understand that if a user is a 5′8″ female that weighs 180 pounds with a BMI of 27.4 and inputs their desired weight for the produced morphed image they want to see as 98 lbs., that would show a BMI of 14.9 which is grossly underweight. Since there is a stop point to the reduction of the image, the image produced to the user would only display the user's image at 128 lbs. This is a BMI of 19.5 and is considered a healthy weight. Using the BMI of the user and or other information such as age, gender, weight, height, measurements, the system understands that it's not realistic to reduce below 128 lbs. Therefore, it stops the reduction of the image, i.e., pixel dropping at the equivalent of 128 lbs. and not 98 lbs. that the user requested. This keeps the images provided to user within a healthy, realistic form. The stop point may also be utilized if calculating the user's morphed image to be displayed with more weight.

To assist the user, the system may provide suggestions of a daily calorie intake and activity level to achieve the look of their displayed morphed image. Utilizing similar calculations that the deep learning computation used to morph the image, may be utilized to provide a diet and exercise plan for the user to achieve the look of their morphed image. Thusly, it may make suggestions from the formed predictions and conclusions of the daily average calorie intake and or exercise for the user to achieve the look of the morphed image and provide the information to the user. For example, after displaying the morphed image to the user, the machine learning and deep learning algorithms may provide, for example, the following calculation to the user: to lose 38 pounds in 3 months, the user will need to reduce their daily calorie intake from a normal maintenance level of 2854 calories per day, down to 1396 calories per day, or exercise more to boost their calorie burn rate by about 1458 calories per day.

For body transformation, the present disclosure utilizes machine learning and Delaunay triangulation and affine transformation. An automatic system for retargeting a human body motion extracted from an image sequence. In mathematics and computational geometry, a Delaunay triangulation for a given set P of discrete points in a plane is a triangulation DT(P) such that no point in P is inside the circumcircle of any triangle in DT(P). An affine transformation is a type of geometric transformation which preserves collinearity and the ratios of distances between points on a line. Geometric contraction, expansion, dilation, reflection, rotation, shear, similarity transformations, spiral similarities, and translation are all affine transformations, as are their combinations. Types of affine transformations include translation-moving a figure, scaling by increasing or decreasing the size of a figure, and rotation-turning a figure about a point. Image morphing utilizing Delaunay Triangles Model (DTM) of the user's silhouette, of which the boundary points are the critical points of the silhouette. We then use a set of affine transformations of Delaunay triangles for the human body motion, which is applied to a new character for the deformation of the subject's Delaunay Triangle Model for pixel warping.

For human parsing, i.e. identifying body part pixels, machine learning and CNN with Encoder-Decoder based network are used. An image consists of the smallest indivisible segments of pixels and every pixel has a strength often known as the pixel intensity. The amount of image morphing and pixel manipulation is based on predictions and conclusions of projected outcomes of the convolutional neural network trained deep learning algorithms and or other artificial networks by dropping, moving, and/or re-segmentation, regenerating pixels, existing pixels or new pixels in the image and or images and or video images. The system may accomplish this by one or more of pixel processing. For example, if the desire is to see the user with more weight, mass and or muscles, and or measurements, pixel regeneration would take place by copying and or moving and or creating new pixels and or regenerating and or copying the pixel next to it from the image and or images and or video images for at least one or more body part and or parts and or area. In another example, if the desire of the user is to see themselves with less weight, mass and or muscle and or measurement, the system may move and or drop and or delete pixels from the image and or images and or video images of at least one or more body part and or parts and or area. This pixel processing may be in one or more body parts and or of a body segment and or overall body of the user.

The present disclosure considers dynamic interaction and increased motivational strength with the user. It processes the image almost instantly and conveniently using a smart phone, tablet or most computer devices. It may also be utilized by capturing the user's image and processing on demand and/or displayed remotely or on any computer device, and or coupled to the device or method such as but not limited to a tablet, cell phone, computer mirror, computer exercise machine, computer desktop, AR and/or VR glasses and/or headset, metaverse or as a hologram. The user's image may be captured and scanned by a 3D scanner first and then processed and displayed on computer glasses, headset, AR and or VR headsets and or hologram and or metaverse, and or smart mirror, tablet, computer and or smart phone. The 3D scanner may be coupled to the computer device or a separate device.

One aspect of this disclosure considers processing the body modification remotely such as in a remote location such as the cloud. However, this disclosure also contemplates directly processing the body modification on the device the user is implementing because the algorithm functions directly with the user live in real time. Our invention uses intuitive algorithms specifically designed to change the user's image intuitively based on the input data that is personalized for each user.

This disclosure contemplates using artificial intelligence, machine learning, artificial neural networks, and deep learning technology that uses large datasets; including the user's data and may use pose detection and restrictions input from computer vision to process information and form predictions and conclusions. Based on the predictions and conclusions the user's body morphing is completed and displayed based on a timeline or straight away to the user. This allows the option for the fully completed body morphing video image be shown at one time or changes to be shown in smaller increments and/or stages over a set period of time if desired and is personalized for each user. This provides a deeper user engagement and motivation towards their fitness goals.

The present disclosure modifies the user's body image for the purpose of motivating the user to eat healthier, exercise and/or show what a particular treatment outcome may look like, such as user entertainment and advertising, among other things.

The present disclosure performs body modification using pose restriction during live capture video directly on the user's image to collect the correct frames. The present disclosure provides a deeper engagement with the user directly based on user inputs

The present disclosure processes the entire body, body parts, body segment that is selected on the original image. The present disclosure is based on the user's or professional's inputs and provides personalization and motivational features.

The present disclosure directly manipulate the user's image. The algorithm of the present disclosure is unique, in part, because it performs body modification directly using the user's image; not an overlay or cartoon. Thusly, the present disclosure provides a more relatable, engaging realistic version of the user that the prior art is missing.

The present disclosure has a personalized connection and engagement with the user. More specifically, the present disclosure uses new unique deep learning and machine learning technology; providing a higher quality and more engaging change in the user's image.

The present disclosure provides for changing the user's image directly without placing a filter on top of the user.

This disclosure provides a personalized approach that depends on user or professional data inputs, allowing the user to see themselves with expected outcomes of the desired outcome, procedure, and/or service.

This disclosure provides a diet and or exercise plan for the user based on the user's morphed body image.

In one aspect of this disclosure, there may be situations where showing a patient that some weight gain may be beneficial. In another example, working with mental illnesses such as anorexia or other disorders, a professional can show the patient slow increments of weight gain to condition them to mentally accept a healthier image. Anorexia is characterized by a distorted body image, with an unwarranted fear of being overweight. A user may want to see what they would look like if they follow a healthy diet and/or exercise routine. This invention could be used as a treatment tool to slowly introduce the weight gain at small increments to the patient or user so that they can begin to accept a different version of their appearance and overcome their fear.

In another example, the modified image could be shown with less or more weight, and/or more muscle mass in smaller increments over a shorter period of time. For example, a user has determined that they want to reach their weight loss and/or muscle mass and/or fitness goals within 12 weeks. If using the invention in this way, once a week the user could see smaller weight loss or weight gain and/or muscle mass modification to their video and/or still image that is calculated several weeks in advance. The modified image displayed to the user, would not be the complete weight loss and or weight gain and/or muscle mass increase and or muscle mass loss goal of the user calculated using 12 weeks as a goal, but smaller increments to keep the user motivated and engaged along the way to reach their 12 week goal. The user feels like their goal is more obtainable, just within reach, and encourages them to keep going and/or the completed body modification may be shown fully at one time.

Fitness manufacturers may want to enhance their customer experience by allowing the user to view their modified body video image while using their exercise machines or pausing the exercise machine or while using a smart mirror device. The user could see an example of what they can expect to look like if they keep up their exercise routine with their fitness instructors. The user could see their complete body modification all at one time or for example, it could be shown to the user in weekly increments that is calculated weeks ahead of time: providing smaller changes over a longer period of time. This could be used in the gym or a school athletic department that's displayed on a smart mirror or most computer devices, that the user could see each week. This provides more motivation to keep going and stick with their fitness goals; making it seem like their goal is just within reach. Although the example given here is of an exercise machine that allows the user to exercise alongside a fitness instructor or class, it is understood that the invention could work with any exercise equipment such as a treadmill, fitness bike, stairmaster, or elliptical machine that has a computer screen whether there is an instructor involved or not.

One aspect of this disclosure considers user's data inputs such as but not limited to gender, height, diet, exercise, non-exercise, BMI, timeline, current weight and/or measurements, pose, desired weight and/or measurements, body parameters, voice command, heart rate, image parameters, and goal setting or the like and/or real time video capture for processing.

One aspect of this disclosure provides a way to manipulate a user's image, among other things, based on a user and/or professional's inputs and goal sets. Additionally, this disclosure contemplates the ability to have a stop point so that the image provided to the user remains within a healthy appearance. Beauty enhancement techniques have come under scrutiny for causing body shaming issues. The present disclosure eliminates potential body shaming issues by creating a stop point that only allows the user's image to reach a certain degree of weight loss or thinness and or weight gain and or muscle mass increase and or decrease in muscle mass, based on a user's BMI, as an example. Manipulating characteristic of a user's real time video image during a consultation at a doctor's office or beauty clinic for a Gastric bypass or Bariatric weight loss surgery, liposuction procedure or other fat reducing cosmetic procedures, or fitness trainer for example, will greatly enhance the display of the expected outcome of the user's body enhancement that is personalized only for that individual user, while promoting good health and sales. The user or professional may want to share their modified video body image on social networks, platforms, devices, and/or networks. In another example, fitness manufactures my want to enhance their customer experience by allowing the user to view their modified body video image while using their exercise machines or smart mirror devices. In another example, working with mental illnesses such as anorexia or other disorders, a professional could show the patient slow increments of weight gain to slowly condition them to mentally accept a healthier image.

The present disclosure provides a method to enhance a real time video body image to modify and heighten the body image such as displaying a thinner stomach area to the user that is based upon inputs from the professional or the user, such as but not limited to the user's body parameters to the image capture, voice command, BMI, heartrate, pose, desired percentage of overall weight or desired measurements of weight loss in a specific area, goal setting, exercise, non-exercise, timeline, diet, surgical or beauty treatments, implants or fitness predicted outcome expectations among other things and/or real time video capture. This can be captured and/or displayed remotely or on any computer device, and or coupled to the device or method such as but not limited to a tablet, cell phone, computer and/or smart mirror, smart television, computer exercise machine, computer desktop, Augmented Reality (“AR”) and/or Virtual Reality (“VR”) glasses and/or headset, metaverse, or as a hologram. The user's image may be captured and scanned by a 3D scanner first and then processed and displayed on computer glasses, headset, AR and or VR headsets and or hologram and or metaverse, and or smart mirror, tablet, computer and or smart phone. The 3D scanner may be coupled to the computer device or a separate device. The real time video and/or still image may be shown as a complete body modification all at once or shown in shorter increments over a longer period. The modified body image may be displayed as the user's entire body that is split down the center to show one side that is their current image, and the other side may be the modified image, this may be a video image or still image. This may be a slider that the user can toggle back and forth from side to side or up and down from top to bottom. This may be the over the entire body or only a body part or specific area. The modified image may be shown beside their original image so that they can see their before and after at the same time. The modified image may be shown as a see through ghostly image and or blurry image on top or bottom of the user's before image. Accordingly, the present disclosure contemplates a method intended to give the user a more engaging and accurate consultation experience as well as setting personalized realistic expectations for results of the cosmetic surgery and/or procedure or exercise and or diet plan.

If used for exercise and diet motivation, the user is able to see realistic healthy outcomes because the enhanced real time video image produced is based on at least one of the user's body parameters to the image capture, personal goals, heartrate, diet, calories, exercise commitments, heartrate, desired percentage reduction or gain, desired measurements or weight percentage change, current and/or future weight percentage and/or measurements, BMI and/or other health data from the user or fitness professional. The user may want to see their modified image completed at once or they may want to see it modified in smaller increments over a longer period of time, for example, once a week. If used in this way, the image enhancement is calculated weeks in advance to keep the user motivated and giving them the sense that their goal is just within reach. Although this example is once a week, it could be any over any time period. The modified body image processing may have stop points so the image provided to the user is a healthy display of the user. The modified body image may be displayed as the user's entire body that is split down the center to show one side that is their current image, and the other side may be the modified image. This may be a slider that the user can toggle back and forth from side to side or up and down from top to bottom. This may be the over the entire body or only a body part or specific area. The modified image may be shown as a see through ghostly image that is on top of or underneath the user's before image. The modified image may be shown beside their original image so that they can see their before and after at the same time. Alternatively, the modified image may be shown on top of the user's current image. The user or professional may want to share the modified image on social media. To assist the user, the system may provide suggestions of a daily calorie intake and activity level to achieve the look of their displayed morphed image. Utilizing similar calculations that the deep learning computation used to morph the image, may be utilized to provide a diet and exercise plan for the user to achieve the look of their morphed image. This can be captured on demand and/or displayed remotely or on any computer device, and or coupled to the device or method such as but not limited to a tablet, cell phone, computer mirror, computer exercise machine, computer desktop, AR and/or VR glasses and/or headset, metaverse, or as a hologram. The user's image may be captured and scanned by a 3D scanner first and then processed and displayed on computer glasses, headset, AR and or VR headsets and or hologram and or metaverse, and or smart mirror, tablet, computer and or smart phone. The 3D scanner may be coupled to the computer device or a separate device.

The artificial intelligence, machine learning, artificial neural networks, and deep learning technologies required are dependent upon the data parameters input by the user, computer vision, or professional to produce the modified body video image. Fitness manufactures my want to enhance their customer experience by allowing the user to view their modified body video image while using their exercise machines or smart mirror devices.

### DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is an exemplary flow chart of data used to train deep neural networks, data processes, morphing process of images and the user's interface flow.

FIG. 2 is an example of the user's before image, deep learning algorithms processing, selecting points on the user's image to modify, and output of user's after image.

FIG. 3 is an example of the body image modification in smaller increments over a time period.

FIG. 4 is an example of an option for the user to see their body modification real time video image as a split screen.

FIG. 5 is an example of the user's input body parameters and or pose restrictions data to the captured device and or computer vision.

FIG. 6, is an example of the invention used while exercising on a treadmill.

FIG. 7, is an example of the invention used with smart glasses.

FIG. 8, is an example of utilizing the invention with a smart mirror.

FIG. 9 is an exemplary flow chart of the invention providing a diet and or weight loss plan to the user that is based on the modified image that is displayed to the user.

Other features and advantages of the present invention will become apparent from the following more detailed description, taken in conjunction with the accompanying drawings, which illustrate, by way of example, the principles of the invention.

### DETAILED DESCRIPTION

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or moreitems, that word covers all of the following interpretations of the word: any of the items in the list, all of the items in the list and any combination of the items in the list.

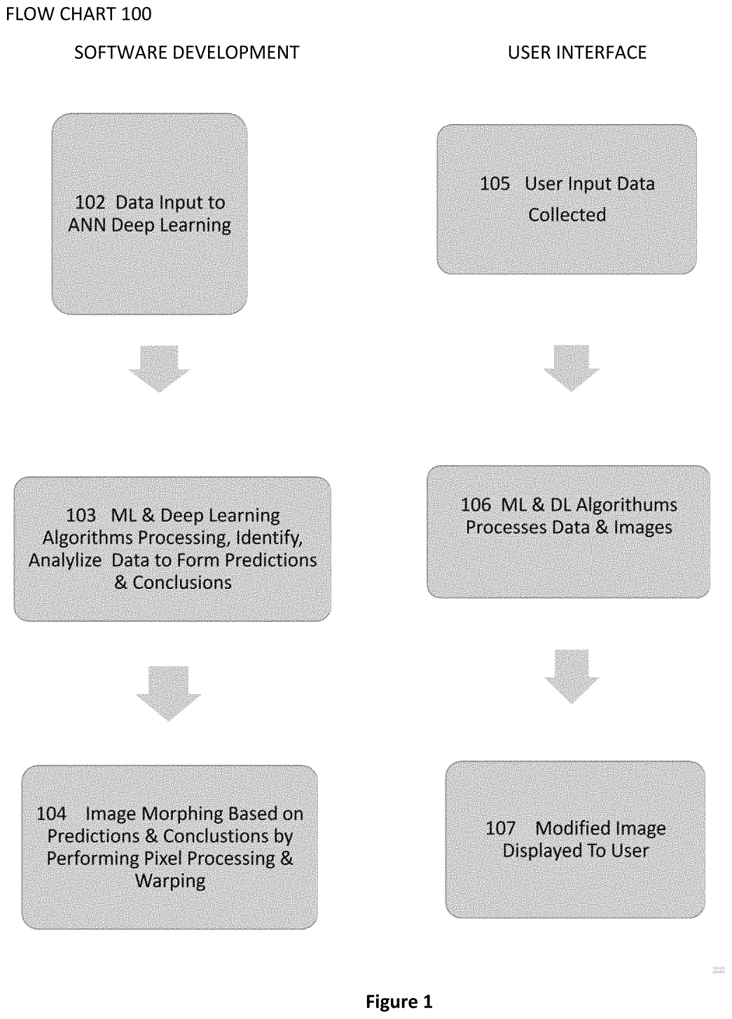

Referring to FIG. 1, an exemplary flow chart 100 of the present disclosure is illustrated. This flow chart 100 may initiate in box In box 102, Artificial neural network are a means of processing machine learning and deep learning, in which a computer learns to perform task by analyzing training examples. Usually, the examples have been hand-labeled in advance. An object recognition system, for instance, might be fed thousands of labeled images of cars, houses, coffee cups, and so on, and it would find visual patterns in the images that consistently correlate with particular labels. There are many classes of artificial neural network deep learning algorithms that are commonly used to train and predict output from complex data, and some are better suited to perform specific task. During the training process, algorithms use unknown elements in the input distribution to extract features, group objects, and discover useful data patterns. Data is fed into a neural network through the input layer, which communicates to hidden layers. This data may include computer vision pose detection algorithms, large amounts of images of whole bodies, body parts, body segments, images of various body sizes, body positions, pose, physical characteristics data, gender, age, weight, height, shapes, body sizes and or weights and or muscle mass dimensions, measurements, timeline, and BMI.

There are many classes of artificial neural network deep learning algorithms that are commonly used to train and predict output from complex data, and some are better suited to perform specific task. For pose detection, we are using Convolutional Neural Network (CNN) based model combined with specialized pose decoding algorithms. Utilizing CNN as an example, works best for analyzing visual imagery, there may be a more suitable neural networks and or additional NN such as Encoder-Decoder Based Network and others that may be used. The Convolutional neural network may use a Graphics Processing Unit also known as GPU, that is utilized to speed up the processing and computations of the CNN. The training of CNN can be quite slow due to the amount of computations required for each iteration. A graphics processing unit (GPU) is a specialized electronic circuit designed to rapidly manipulate and alter memory to accelerate the creation of images and intensive graphics-based tasks, such as video rendering that often require a dedicated or discreet GPU notably in the form of a graphics card. GPUs can perform multiple, simultaneous computations. This enables the distribution of training processes and can significantly speed machine learning operations. With GPUs, you can accumulate many cores that use fewer resources without sacrificing efficiency or power. Although we have included the use of GPU it is not necessary to utilize a GPU when working with a CNN.

In box 103, Machine learning and Deep learning algorithms are highly efficient and can now process information to form conclusions and predications. The deep learning algorithms can process complex data for the output.

Processing takes place in the hidden layers through a system of weighted connections. Nodes in the hidden layer then combine data from the input layer with a set of coefficients and assigns appropriate weights to inputs. These input-weight products are then summed up. The sum is passed through a node's activation function, which determines the extent that a signal must progress further through the network to affect the final output. Finally, the hidden layers link to the output layer—where the outputs are retrieved.

Modeled loosely on the human brain, a neural net consists of thousands or even millions of simple processing nodes that are densely interconnected. Some of today's neural nets are organized into layers of nodes, and they're “feed-forward,” meaning that data moves through them in only one direction. An individual node might be connected to several nodes in the layer beneath it, from which it receives data, and several nodes in the layer above it, to which it sends data. Nodes are activated when there is sufficient stimuli or input. This activation spreads throughout the network, creating a response to the stimuli (output). The connections between these artificial neurons act as simple synapses, enabling signals to be transmitted from one to another. Signals across layers as they travel from the first input to the last output layer—and get processed along the way. To each of its incoming connections, a node will assign a number known as a “weight.” When the network is active, the node receives a different data item—a different number—over each of its connections and multiplies it by the associated weight. It then adds the resulting products together, yielding a single number. If that number is below a threshold value, the node passes no data to the next layer. If the number exceeds the threshold value, the node “fires,” which in today's neural nets generally means sending the number—the sum of the weighted inputs—along all its outgoing connections. Based on a task and or problem the deep learning algorithms are ready to act on those predictions to produce predicted outcomes.

In box 104, utilizing the formed predictions and conclusions, the deep learning algorithms can now rapidly manipulate, morph and alter the image by warping, dropping, moving, and/or regenerating pixels, existing pixels or new pixels in the image and or images and or real time video images. The system may accomplish this by one or more of pixel processing. For example, if the desire is to see the user with more weight, increase body mass and or muscles, and or measurements, pixel regeneration would take place by copying, expanding and or moving and or creating new pixels and or regenerating the pixel next to it from the image and or images and or video images for at least one or more body part and or parts and or area. In another example, if the desire of the user is to see themselves with less weight, mass and or muscle and or measurement, the system my move and or drop, minimize and or delete pixels from the image and or images and or real time video images of at least one or more body part and or parts and or area. This pixel processing may be in one or more body parts and or of a body segment and or overall body of the user.

In box 105 the user's input data is collected from computer vision, voice command, professional and or user of one or more of diet, exercise, non-exercise, timeline, fat loss desired, desired measurements, body parameters to image capturing, live pose restrictions, 3D scanner, measurements increase and or decrease, pose, image, real time video image, or percentage of weight gain and or weight loss of at least one body part and or area, current weight and/or body fat, current measurements, heart rate, gender, height, BMI, goal settings and/or cosmetic surgery and or procedure predicted outcome, body implant and or removal among other things of at least one body part and or area. Inputs may be collected on a device or from a remote location.

Artificial intelligence, computer vision, and or specialized pose restriction algorithms or the like can be used to capture a user's real time image so the correct frames are collected and detect key data points on a user's frame. The computer vision may have access to a camera or the like and real time image or video images of the user may be captured or uploaded from a remote location and or database to the computer device, and or coupled to the device for further analysis. A marker-based or markerless optical motion capturing system may extract the user's skeleton frame using the user's real time image. The user's skeleton may be extracted using any method know in the art and some non-exclusive examples include OpenPose engine and Kinect-based markerless systems. A non-exclusive example, OpenCV is a cross-platform, open-source, real-time computer vision library. It has algorithms that can detect human features, identify objects, classify human actions in videos, track objects, follow eye movements, recognize scenery, and more. It works in real-time. However, any known system that can analyze an image is considered herein. In one aspect of this disclosure, at least one body part measurements may also be detected. The artificial intelligence may utilize any one or more of these traits to further analyze the user.

In box 106, Machine learning and deep learning algorithms process user data inputs and image, images and or video image. Collecting and processing may be coupled to the machine or remote location.

In box 107, The morphed image is displayed to the user. This may be a still image or real time video images. This may be display on most computer devices, and or coupled to the device and or system and or displayed from a remote location and or coupled to the machine. Such as but not limited to, computer screen, smart phone, computer tablet, computer mirror, smart tv, exercise equipment, wearable computer, smart glasses, a VR or AR headset, Metaverse and or hologram.

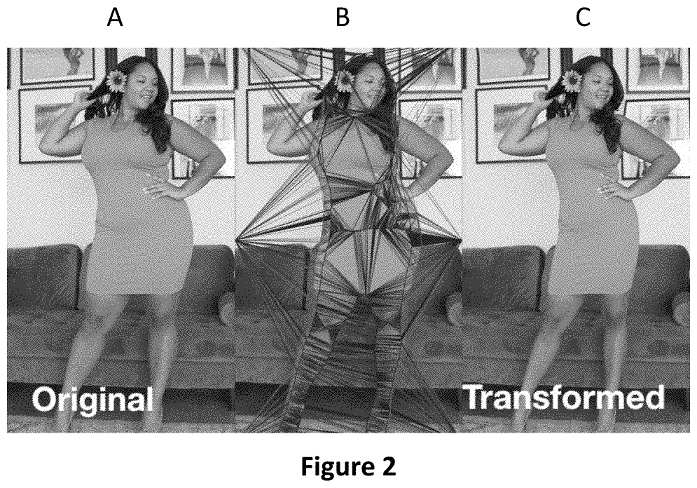

Referring to FIG. 2, Frame A, an example of the user's heavier image before body morphing. Frame B, is an example of the body part segmentation/warping. The body transformation processes using body pose detection and Delaunay triangulation and affine transformation for pixel warping. Frame C, is an example of the user's thinner image after morphing is completed to form a different transformed shape. Although this example illustrates weight loss of a user, it is understood that a display of weight gain, additional muscle mass and or reduction in muscle mass, can also be provided after processing. Body transformation may be in one or more body parts and or of a body segment and or overall body of the user.

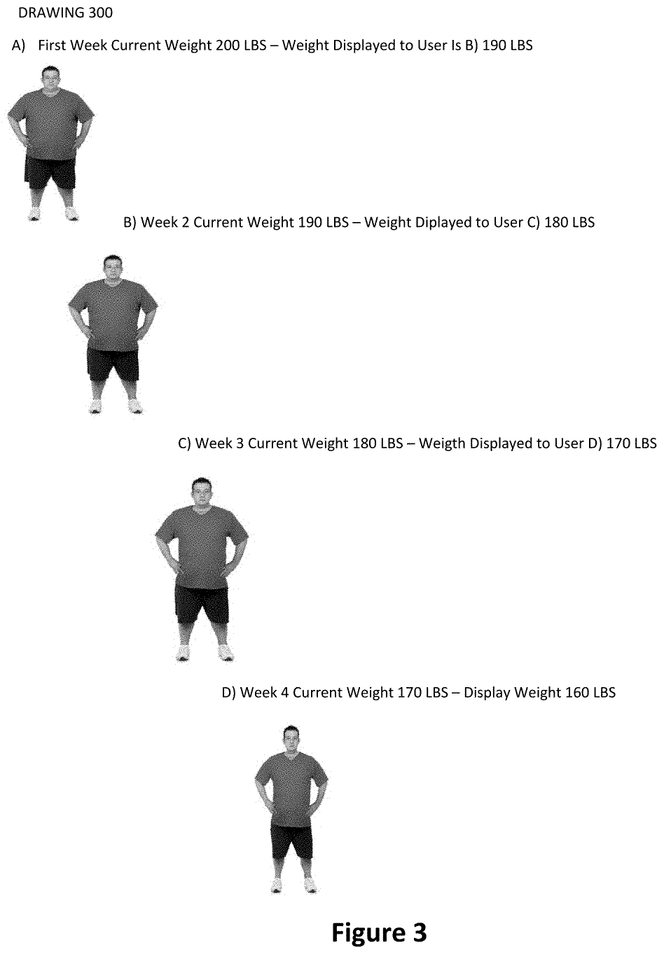

Referring to FIG. 3, is an example of the user's body modification that is calculated over a longer period of time and is shown to the user in smaller increments. The software calculates what the image will look like in advance and displays a user's weight transformation in smaller adjustments. Model A, during the first week of the goal timeline the user views himself as model B. When Model A is in the second week of his goal timeline, he views himself as Model C.

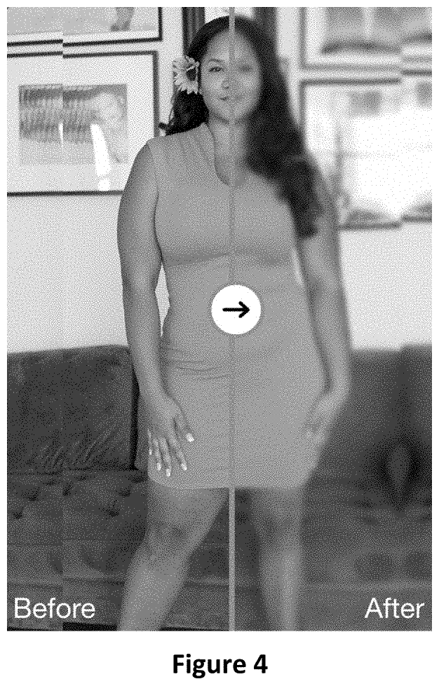

Referring to FIG. 4, is an example of the user's modified image shown as a split screen. The user is able to see their before morphing image and their after morphing image that is processed side by side. This may be a real time video body image or still image. There may be a toggle slider so the user can see the image partially or fully.

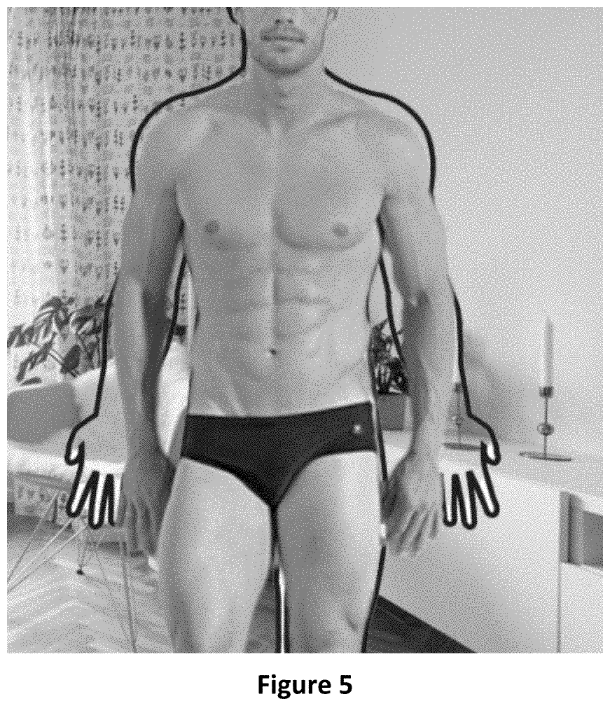

Referring to FIG. 5, an example of the user's input body pose restrictions data and computer vision utilizing the image capture device is illustrated. The user stands within a defined area to provide the current image data to the machine. The algorithm allows the outlined area to change colors from red to green once it detects the user is within the correct restricted area so the correct frames are collected. In one aspect of this disclosure, the live pose restriction is outlined on the screen and the user stands within the outlined pose restriction. If done correctly, an indicator turns green and the user's image is captured in the correct pose. This allows the image capture device to restrict the pose during the capture process and only capture the correct frames and rejecting the others.

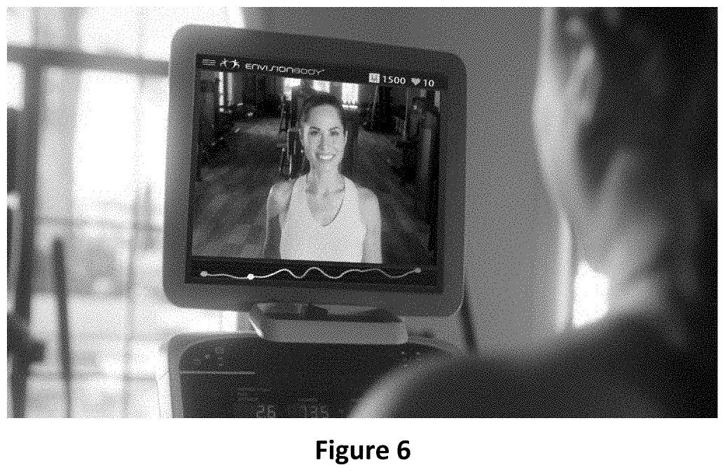

Referring to FIG. 6, is an example of the invention used while exercising on a treadmill. Because the software can operate on most computer devices, this illustrates a user exercising on a treadmill while viewing their body modification.

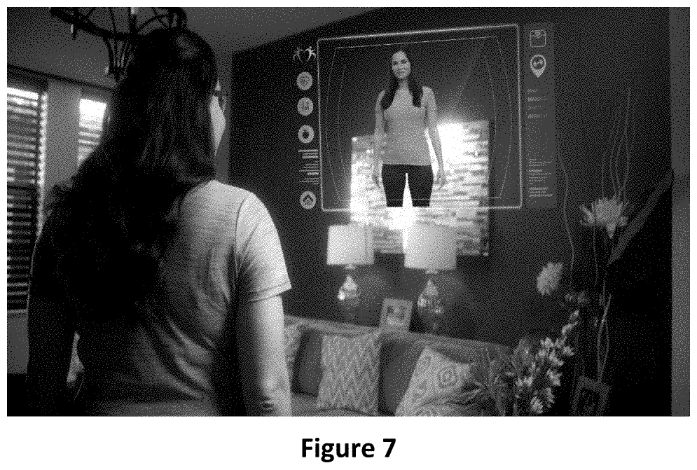

Referring to FIG. 7, is an example of the software used with smart glasses. The user is able to see their body modification utilizing smart glasses or other computer headsets. The real time user's body image may be captured by a 3D scanner, process and displayed on smart glasses.

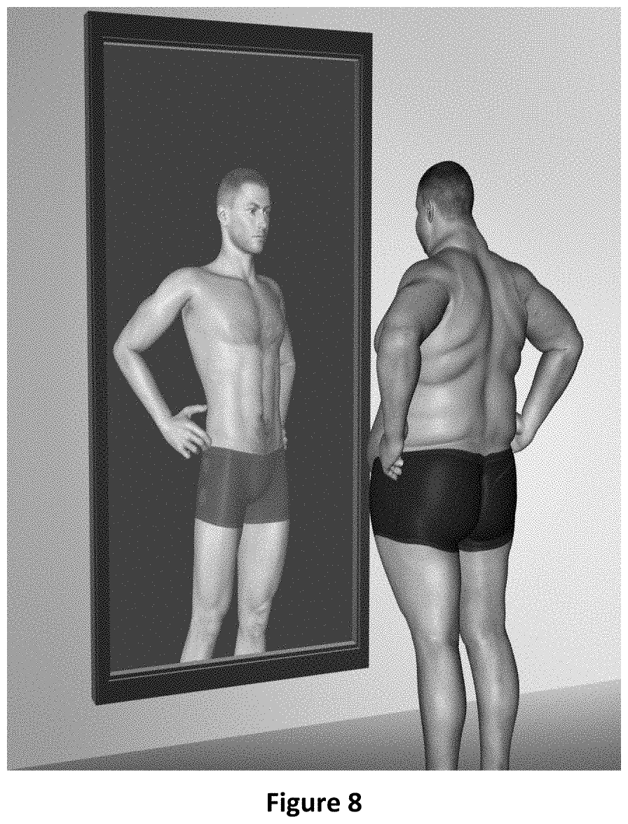

Referring to FIG. 8, is an example of a user utilizing a smart mirror while using the invention. The large size of the smart mirror conveniently allows the user to view their entire body while implementing the video image body modification.

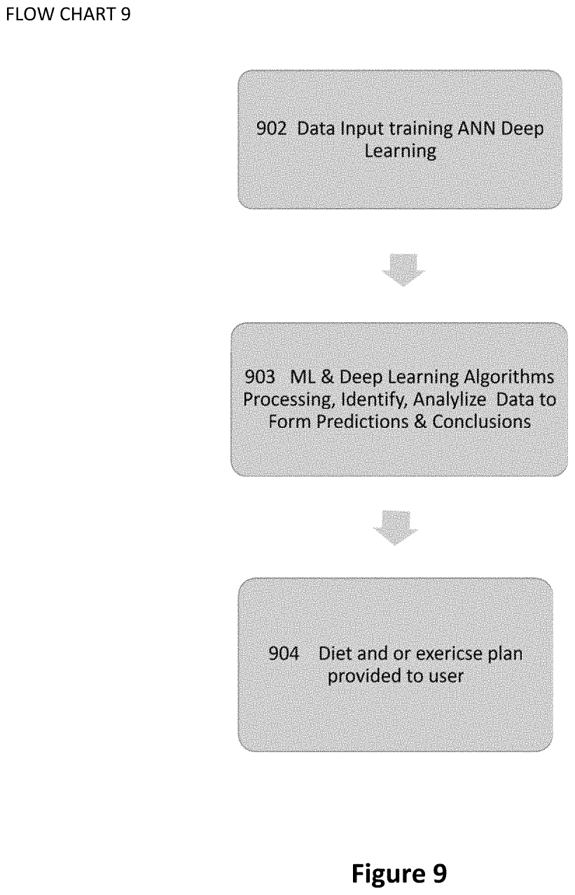

Referring to FIG. 9, an exemplary flow chart 900 is illustrated. The flow chart 900 is configured to assist the user. More specifically, the system may provide suggestions of a daily calorie intake and or activity level to achieve the look of their displayed morphed image. Deep learning algorithms may be utilized to provide a diet and exercise plan for the user to achieve the look of their morphed image. Thusly, it may make suggestions from the formed predictions and conclusions of the daily average calorie intake and or exercise for the user to achieve the look of the morphed image and provide the information to the user.

This flow chart 900 may initiate in box 902. More specifically, artificial neural network are a means to train deep learning models to form predictions of outcomes relative to before and after images related to the effects of a particular daily calorie intake and or exercise performed by the user. This is achieved by feeding the Artificial neural network large amounts of before and after weight loss and or weight gain images that are associated with a diet and or daily calorie intake. Various daily total calorie intake scenarios are inputted that include the image associated with the effects of the calorie intake on the image. The size reduction or gain to the image associated with the diet is used for computations. Large datasets of various exercises such as cardiovascular movement and or weightlifting are inputted along with the associated image change related to the effects of various exercises on the body and or body part.

In box 903, machine learning and deep learning trained algorithms process computational formulas to form predictions and conclusions. Highly trained deep learning models run various computations millions of times comparing various outcomes to recognize patterns. This will allow transformation of the values to produce an accurate outcome based on a task. The deep learning algorithms are ready to act on those predictions to produce predicted outcomes.

In box 904, based on conclusions and predicted outcomes, a diet and or exercise plan are provided to the user that are based on the morphed image size.

While a particular form of the invention has been illustrated and described, it will be apparent that various modifications can be made without departing from the spirit and scope of the invention. For example, the system may be adapted to be used for a group of people, such as a yoga or exercise class. Alternately, the system may be adapted for use by people who are not exercising on an exercising machine. For example, mental health patients might use the system to assist in positive self-imagery such autonomy exercises. Additionally, the software may be used on a user's personal cell phone as they are mobile or in the metaverse.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. In addition, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

1. A method for changing a body image, comprising:
inputting data parameters into a computing device;
providing an image to a machine;
manipulating the image; and
displaying the manipulated image;
wherein the machine utilizes one or more of artificial intelligence, machine learning, artificial neural networks, and deep learning to provide the modified image.

2. The method of claim 1, wherein the image is uploaded to the machine from a remote location.

3. The method of claim 1, wherein the image is uploaded to the machine from a remote device.

4. The method of claim 1, wherein the image is captured by the machine through a camera coupled to the machine;
wherein the image is saved on one or more of a remote server, the computing device, the metaverse, or shared on social media.

5. The method of claim 1, wherein the machine has an image capturing device in a remote location;
wherein the image is one of a still image, real time image, or a video image.

6. (canceled)

7. The method of claim 1, wherein the image is a real time image of a user and the modified image comprises a change to one or more of: diet, calories, exercise, timeline, pose, percentage of weight loss or fat loss desired, body parameters, measurements reduction desired, measurements or percentage of weight gain, a change to at least one body part, a weight, a body fat amount, muscle mass, the user's current or desired measurements, a heart rate, a gender, a height, a BMI, goal settings, or cosmetic surgery or service or a procedure's predicted outcome;
wherein the image change is based on at least one input of a user's body pose restrictions, voice command, body parameter, personal goals, heartrate, diet, calories, exercise commitments, desired percentage of body shape reduction or gain, current weight, height, age, gender, desired measurements or desired weight percentage change, achieved weight change, current or future weight percentage and measurements, and BMI.

8. The method of claim 1, wherein artificial intelligence and computer vision captures a real time video of a user's body image and detects one or more of 2D and 3D data points on a user's frame.

9. The method of claim 1, wherein artificial intelligence and computer vision is a marker based or markerless optical motion capturing system that extracts the user's frame using the user's image;
wherein the motion capturing system utilizes a live video feed and pose restriction algorithms to estimate a pose of the live video feed.

10. (canceled)

11. The method of claim 1, wherein the machine detects at least one body part measurement;
wherein measurements of one or more body part is processed through an algorithm in computational geometry application to manipulate the frame;
wherein the user's image is manipulated making it one or more of thinner, more muscular, heavier, and less muscular.

12. The method of claim 1, wherein the neural networks and deep learning uses algorithms to parse data and learn from the data;
wherein one or more of the machine learning, neural networks, mathematical calculations are combined with deep learning structured algorithms used to create and estimate future shapes that are within predefined stop points.

13. (canceled)

14. (canceled)

15. (canceled)

16. (canceled)

17. (canceled)

18. The method of claim 1, wherein the image is a real time image of a user and the modified image is representative of a one or more of a change to the user's diet a change to the user's exercise routine, a change to the user's selected weight, a change to the user's physical measurements, a change to at least one of the user's body parts, a change to the user's a body fat amount, a change to the user's a heart rate, a change to the user's body mass index, a change to the user after a cosmetic service or surgery procedure.

19. (canceled)

20. (canceled)

21. (canceled)

22. (canceled)

23. (canceled)

24. (canceled)

25. (canceled)

26. (canceled)

27. The method of claim 1, wherein the image is modified in increments to show an expected change to the image over a different amount of time.

28. The method of claim 1, wherein the image is a real time image of a user and the modified image comprises one or more of a change based on user inputs and a change based on pose restrictions;
wherein the user inputs may be one or more of diet, calories, exercise, non-exercise, timeline, pose, voice, percentage of weight loss or fat loss desired, body parameters, measurements reduction desired, measurements or percentage of weight gain, a change to at least one body part, a weight, a body fat amount, the user's current or desired measurements, a heart rate, a gender, a height, a BMI, goal settings, or cosmetic surgery or a procedure's predicted outcome.

29. (canceled)

30. (canceled)

31. (canceled)

32. The method of claim 1, wherein the neural network is combined with pose restriction algorithms to estimate pose;
wherein the neural network is combined with pose restriction algorithms to detect body parts.

33. (canceled)

34. The method of claim 1, wherein artificial intelligence processes a real time video of a user's body image and detects a pose restriction.

35. The method of claim 1, wherein artificial intelligence processes a real time video of a user's body image and executes a pose decoding to determine the pose of the user's body image in the real time video;
wherein artificial intelligence and computer vision processes a real time video of a user's body image and restricts a pose position.

36. (canceled)

37. The method of claim 1, wherein the modified image displayed is a real time video body image output to the user as a split before and after modification image.

38. The method of claim 1, wherein the image is displayed as a still body image output to the user;
wherein the image is modified to show a change to the image in increments.

39. (canceled)

40. The method of claim 1, wherein artificial intelligence and computer vision processes a real time video of a user's body image and restricts a pose position.

41. The method of claim 1, wherein the deep learning provides diet and activity recommendations based on modified image.
